(19) United States
(12) Patent Application Publication
(10) Pub. No.: US 2016/0162039 A1
(43) Pub. Date: Jun. 9, 2016

(54) METHOD AND SYSTEM FOR TOUCHLESS ACTIVATION OF A DEVICE

(71) Applicant: POINTGRAB LTD., HOD HASHARON (IL)

(72) Inventors: ERAN EILAT, GIVATAYIM (IL); Assaf GAD, Holon (IL); Haim PERSKI, Hod-HaSharon (IL)

(21) Appl. No.: 14/906,559

(22) PCT Filed: Jul. 21, 2014
(86) PCT No.: PCT/IL2014/050660

§ 371 Date: Jan. 21, 2016

Related U.S. Application Data
(60) Provisional application No. 61/856,724, filed on Jul. 21, 2013.
(60) Provisional application No. 61/896,692, filed on Oct. 29, 2013.

(51) Int. Cl. G06F 3/01; G06T 7/00; G06K 9/00; G06F 3/00

(52) U.S. Cl. CPC G06F 3/017; G06F 3/005; G06T 7/0051; G06K 9/00228; G06K 9/00335; G06T 7/0042; G06T 2207/30244

(57) ABSTRACT

A method and system are provided for computer vision based control of a device by obtaining an image via a camera, the camera in communication with a device; detecting in the image a user pointing at the camera; and controlling the device based on the detection of the user pointing at the camera.

### FIELD OF THE INVENTION

The present invention relates to the field of hand recognition based control of electronic devices. Specifically, the invention relates to touchless activation and other control of a device.

### BACKGROUND

The need for more convenient, intuitive and portable input devices increases, as computers and other electronic devices become more prevalent in our everyday life.

Recently, human gesturing, such as hand gesturing, has been suggested as a user interface input tool in which a hand gesture is detected by a camera and is translated into a specific command. Gesture recognition enables humans to interface with machines and interact naturally without any mechanical appliances. The development of alternative computer interfaces (forgoing the traditional keyboard and mouse), video games and remote controlling are only some of the fields that may implement human gesturing techniques.

Recognition of a hand gesture may require identification of an object as a hand and tracking the identified hand to detect a posture or gesture that is being performed.

Currently, personal computer devices and other mobile devices may include software or dedicated hardware to enable hand gesture control of the device however due to the significant resources needed for hand gesture control, this control mode is typically not part of the basic device operation but must be specifically triggered. A device must typically be already operating in some basic mode in order to enter hand gesture control mode.

Typically, a device being controlled by gestures includes a user interface, such as a display, allowing the user to interact with the device through the interface and to get feedback regarding his operations. However, only a limited number of devices and home appliances include displays or other user interfaces that allow a user to interact with them.

Additionally, in a home environment there is usually more than one device. Currently, there is no accurate method for selectively activating a device without interacting with a display of that device.

Thus, touchless control of devices in a typical home setting is still limited.

Activation of devices using human voice recognition is also known. Voice recognition capabilities can be found in computer operating systems, commercial software for computers, mobile phones, cars, call centers, internet search engines, home appliances and more.

Some systems offer gesture recognition and voice recognition capabilities, enabling a user to control devices either by voice or by gestures. Both modalities (voice control and gesture control) are enabled simultaneously and a user signals his desire to use one of the modalities by means of an initializing signal. For example, the Samsung™ Smart TV™ product enables voice control options once a specific phrase is said out loud by the user. Gesture control options are enabled once a user raises his hand in front of a camera attached to the TV. In cases where the Smart TV™ microphone does not pick up the user's voice as a signal, the user may talk into a microphone on a remote control device, to reinforce the initiation voice signal.

The difficulties in picking up a voice signal, on one hand, and the risk of causing unintended activation (e.g., due to users talking in the background), on the other hand, leave voice controlled systems much to be desired.

### SUMMARY

Embodiments of the present invention provide methods and systems for touchless activation and/or other control of a device.

Activation and/or other control of a device, according to embodiments of the invention, include the user indicating a device (e.g., if there are several devices, indicating which of the several devices) and a system being able to detect which device the user is indicating and is able to control the device accordingly. Detecting which device is being indicated according to embodiments of the invention, and activating the device based on this identification enables activating and otherwise controlling the device without requiring interaction with a user interface.

For example, methods and systems according to embodiments of the invention provide accurate and simple activation or enablement of a voice control mode. A user may utilize a gesture or posture of his hand to enable voice control of a device, thereby eliminating the risk of unintentionally activating voice control through unintended talking and eliminating the need to speak up loudly or talk into a special microphone in order to enable voice control in a device.

According to one embodiment a V-like shaped posture is used to control voice control of a device. This easy and intuitive control of a device is enabled, according to one embodiment, based on detection of a shape of a user's hand.

### BRIEF DESCRIPTION OF THE FIGURES

The invention will now be described in relation to certain examples and embodiments with reference to the following illustrative figures so that it may be more fully understood. In the drawings:

FIG. 1 is a schematic illustration of a system according to embodiments of the invention;

FIG. 2A is a schematic illustration of a system to identify a pointing user, according to embodiments of the invention;

FIG. 2B is a schematic illustration of a system controlled by identification of a pointing user, according to embodiments of the invention;

FIG. 2C is a schematic illustration of a system for control of voice control of a device, according to one embodiment of the invention;

FIG. 3 is a schematic illustration of a method for detecting a pointing user, according to embodiments of the invention;

FIG. 4 is a schematic illustration of a method for detecting a pointing user by detecting a combined shape, according to embodiments of the invention;

FIG. 5 is a schematic illustration of a method for detecting a pointing user by detecting an occluded face, according to embodiments of the invention;

FIG. 6 is a schematic illustration of a system for controlling a device in a multi-device environment, according to an embodiment of the invention;

FIG. 7 is a schematic illustration of a method for controlling a device based on location of a hand in an image compared to a reference point in a reference image, according to an embodiment of the invention;

FIG. 8 is a schematic illustration of a method for controlling a voice controlled mode of a device, according to embodiments of the invention; and

FIG. 9 schematically illustrates a method for toggling between voice control enable and disable, according to embodiments of the invention.

### DETAILED DESCRIPTION OF THE INVENTION

Methods according to embodiments of the invention may be implemented in a system which includes a device to be operated by a user and an image sensor which is in communication with a processor. The image sensor obtains image data (typically of the user) and sends it to the processor to perform image analysis and to generate user commands to the device based on the image analysis, thereby controlling the device based on computer vision.

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

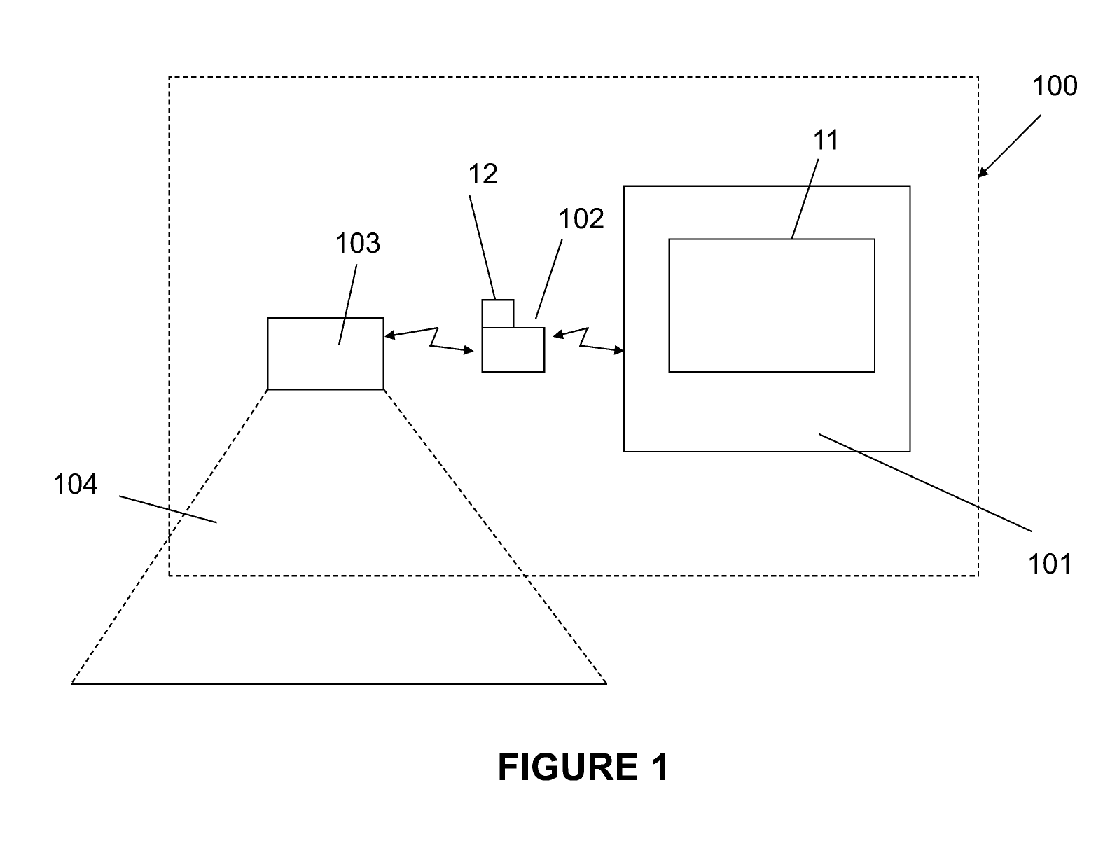

An exemplary system, according to one embodiment of the invention, is schematically described in FIG. 1, however, other systems may carry out embodiments of the present invention.

The system 100 may include an image sensor 103, typically associated with a processor 102, memory 12, and a device 101. The image sensor 103 sends the processor 102 image data of field of view (FOV) 104 to be analyzed by processor 102. Typically, image signal processing algorithms and/or image acquisition algorithms may be run in processor 102. According to one embodiment a user command is generated by processor 102 or by another processor, based on the image analysis, and is sent to the device 101. According to some embodiments the image processing is performed by a first processor which then sends a signal to a second processor in which a user command is generated based on the signal from the first processor.

Processor 102 may include, for example, one or more processors and may be a central processing unit (CPU), a digital signal processor (DSP), a microprocessor, a controller, a chip, a microchip, an integrated circuit (IC), or any other suitable multi-purpose or specific processor or controller.

Memory unit(s) 12 may include, for example, a random access memory (RAM), a dynamic RAM (DRAM), a flash memory, a volatile memory, a non-volatile memory, a cache memory, a buffer, a short term memory unit, a long term memory unit, or other suitable memory units or storage units.

The device 101 may be any electronic device or home appliance that can accept user commands, e.g., TV, DVD player, PC, mobile phone, camera, set top box (STB) or streamer, smart home console or specific home appliances such as an air conditioner, etc. According to one embodiment, device 101 is an electronic device available with an integrated standard 2D camera. The device 101 may include a display or a display may be separate from but in communication with the device 101.

The processor 102 may be integral to the image sensor 103 or may be a separate unit. Alternatively, the processor 102 may be integrated within the device 101. According to other embodiments a first processor may be integrated within the image sensor and a second processor may be integrated within the device.

The communication between the image sensor 103 and processor 102 and/or between the processor 102 and the device 101 may be through a wired or wireless link, such as through infrared (IR) communication, radio transmission, Bluetooth technology and other suitable communication routes.

According to one embodiment the image sensor 103 may include a CCD or CMOS or other appropriate chip. The image sensor 103 may be included in a camera such as a forward facing camera, typically, a standard 2D camera such as a webcam or other standard video capture device, typically installed on PCs or other electronic devices. A 3D camera or stereoscopic camera may also be used according to embodiments of the invention.

The image sensor 103 may obtain frames at varying frame rates. In one embodiment of the invention, image sensor 103 receives image frames at a first frame rate; and when a predetermined shape of an object (e.g., a shape of a user pointing at the image sensor) is detected (e.g., by applying a shape detection algorithm on an image frame(s) received at the first frame rate to detect the predetermined shape of the object, by processor 102) the frame rate is changed and the image sensor 103 receives image frames at a second frame rate. Typically, the second frame rate is larger than the first frame rate. For example, the first frame rate may be 1 fps (frames per second) and the second frame rate may be 30 fps. The device 101 can then be controlled based on the predetermined shape of the object and/or based on additional shapes detected in images obtained in the second frame rate.

Detection of the predetermined shape of the object (typically detected in the first frame rate), e.g., a predetermined shape of a user (such as a user using his hand in a specific posture) can generate a command to turn the device 101 on or off. Images obtained in the second frame rate can then be used for tracking the object and for further controlling the device, e.g., based on identification of postures and/or gestures performed by at least part of a user's hand.

According to one embodiment a first processor, such as a low power image signal processor may be used to identify the predetermined shape of the user whereas a second, possibly higher power processor may be used to track the user's hand and identify further postures and/or shapes of the user's hand or other body parts.

Gestures or postures performed by a user's hand may be detected by applying shape detection algorithms on the images received at the second frame rate. At least part of a user's hand may be detected in the image frames received at the second frame rate and the device may be controlled based on the shape of the part of the user's hand.

According to some embodiments different postures are used for turning a device on/off and for further controlling the device. Thus, the shape detected in the image frames received at the first frame rate may be different than the shape detected in the image frames received at the second frame rate.

According to some embodiments the change from a first frame rate to a second frame rate is to increase the frame rate such that the second frame rate is larger than the first frame rate. Receiving image frames at a larger frame rate can serve to increase speed of reaction of the system in the further control of the device.

According to some embodiments image data may be stored in processor 102, for example in a cache memory. Processor 102 can apply image analysis algorithms, such as motion detection and shape recognition algorithms to identify and further track the user's hand. Processor 102 may perform methods according to embodiments discussed herein by for example executing software or instructions stored in memory 12.

According to embodiments of the invention shape recognition algorithms may include, for example, an algorithm which calculates Haar-like features in a Viola-Jones object detection framework. Once a shape of a hand is detected the hand shape may be tracked through a series of images using known methods for tracking selected features, such as optical flow techniques. A hand shape may be searched in every image or at a different frequency (e.g., once every 5 images, once every 20 images or other appropriate frequencies) to update the location of the hand to avoid drifting of the tracking of the hand.

When discussed herein, a processor such as processor 102 which may carry out all or part of a method as discussed herein, may be configured to carry out the method by, for example, being associated with or connected to a memory such as memory 12 storing code or software which, when executed by the processor, carry out the method.

Optionally, the system 100 may include an electronic display 11. According to embodiments of the invention, mouse emulation and/or control of a cursor on a display, are based on computer visual identification and tracking of a user's hand, for example, as detailed above.

Different embodiments are disclosed herein. Features of certain embodiments may be combined with features of other embodiments; thus certain embodiments may be combinations of features of multiple embodiments.

Embodiments of the invention may include an article such as a computer or processor readable non-transitory storage medium, such as for example a memory, a disk drive, or a USB flash memory encoding, including or storing instructions, e.g., computer-executable instructions, which when executed by a processor or controller, cause the processor or controller to carry out methods disclosed herein.

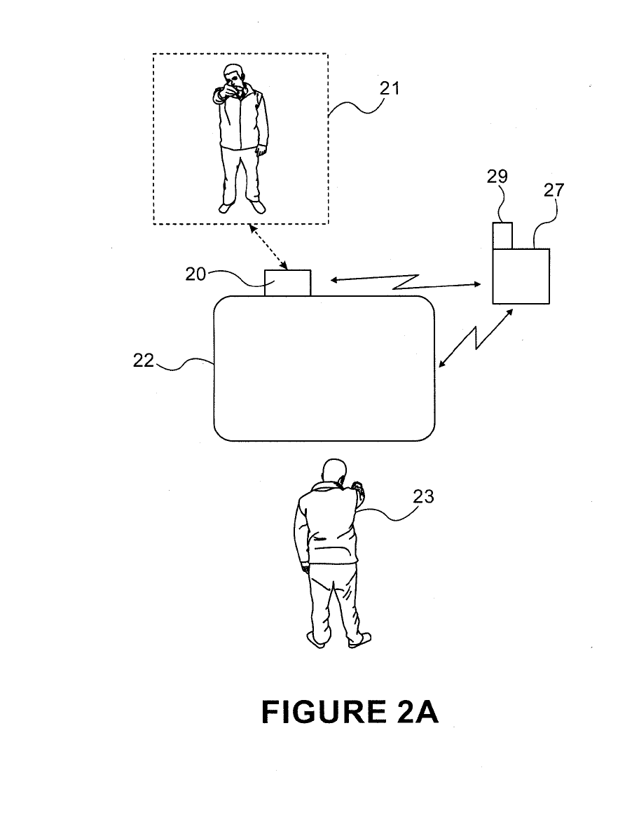

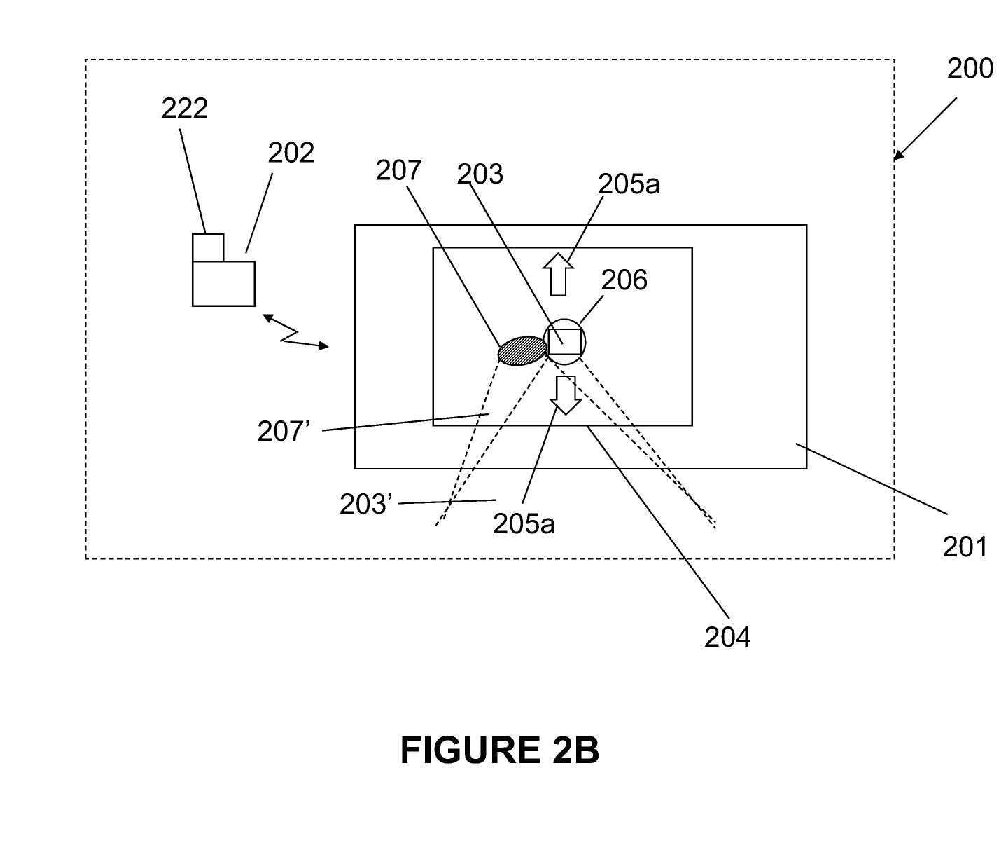

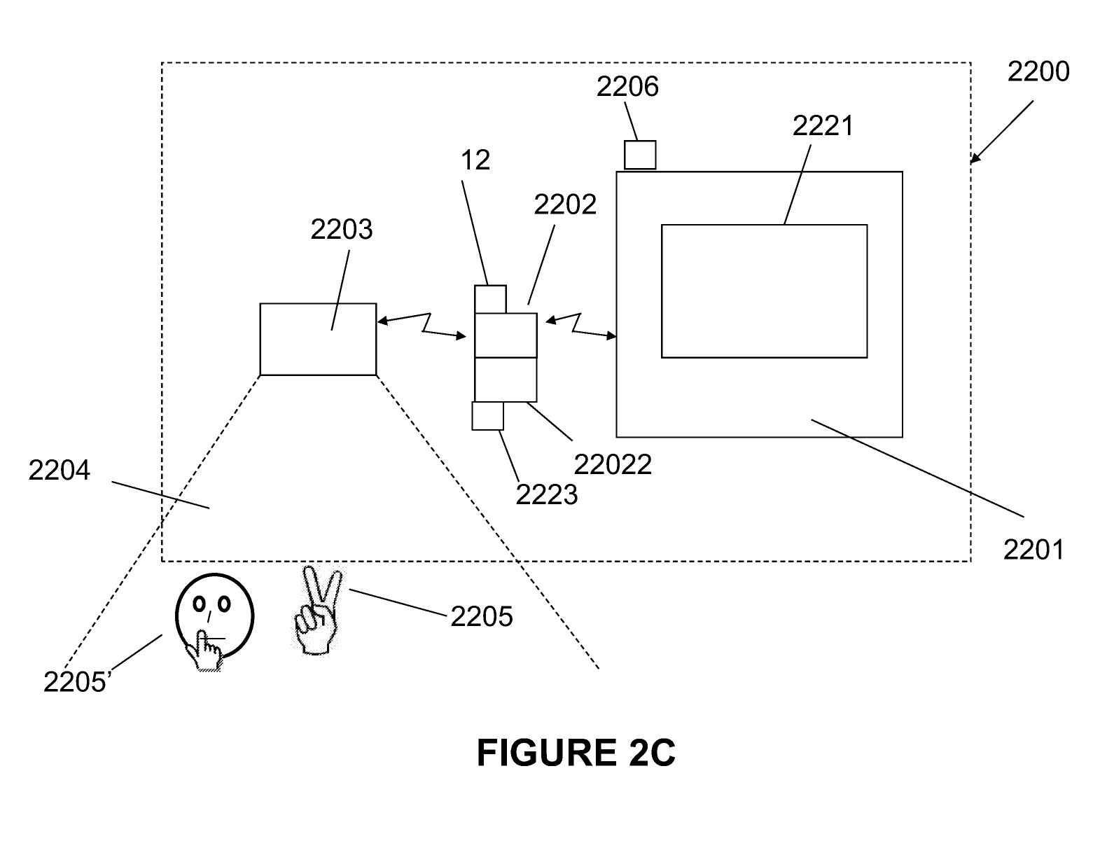

Methods according to embodiments of the invention include obtaining an image via a camera, said camera being in communication with a device, and detecting in the image a predetermined shape of an object, e.g., a user pointing at the camera. The device may then be controlled based on the detection of the user pointing at the camera. For example, as schematically illustrated in FIG. 2A, camera 20 which is in communication with device 22 and processor 27 (which may perform methods according to embodiments of the invention by, for example, executing software or instructions stored in memory 29), obtains an image 21 of a user 23 pointing at the camera 20. Once a user pointing at the camera is detected, e.g., by processor 27, a command may be generated to control the device 22. According to one embodiment the command to control the device 22 is an ON/OFF command. According to another embodiment detection, by a first processor, of the user pointing at the camera may cause a command to be generated to start using a second processor to further detect user gestures and postures and/or to change frame rate of the camera 20 and/or a command to control the device 22 ON/OFF and/or other commands.

In one embodiment a face recognition algorithm may be applied (e.g., in processor 27 or another processor) to identify the user and generating a command to control the device 22 (e.g., in processor 27 or another processor) may be enabled or not based on the identification of the user.

In some embodiments the system may include a feedback system which may include a light source, buzzer or sound emitting component or other component to provide an alert to the user of the detection of the user's identity or of the detection of a user pointing at the camera.

Communication between the camera 20 and the device 22 may be through a wired or wireless link including processor 27 and memory 29, such as described above.

According to one embodiment, schematically illustrated in FIG. 2B, a system 200 includes camera 203, typically associated with a processor 202, memory 222, and a device 201.

According to one embodiment the camera 203 is attached to or integrated in device 201 such that when a user (not shown) indicates at the device 201, he is essentially indicating at the camera 203. According to one embodiment the user may indicate at a point relative to the camera. The point relative to the camera may be a point at a predetermined location relative to the camera.

For example, locations above or below the camera or to the right/left of the camera may be designated for specific controls of an appliance. For example, the device 201, which may be an electronic device or home appliance that can accept user commands, e.g., TV, DVD player, PC, mobile phone, camera, set top box (STB) or streamer, smart home console or specific home appliances such as an illumination fixture, an air conditioner, etc., may include a panel 204, which may include marks 205a and/or 205b, which, when placed on the device 201, are located at predetermined locations relative to the camera 203 (for example, above and below camera 203).

According to one embodiment the panel 204 may include a camera view opening 206 which may accommodate the camera 203 or at least the optics of the camera 203. The camera view opening 206 may include lenses or other optical elements.

In some embodiments mark 205a and/or 205b may be at a predetermined location relative to the camera view opening 206. If the user is indicating at the mark 205a or 205b then the processor 202 may control output of the device 201. For example, a user may turn on a light source by indicating at camera view opening 206 and then by indicating at mark 205a the user may make the light brighter and by indicating at mark 205b the user may dim the light.

According to one embodiment the panel 204 may include an indicator 207 configured to create an indicator FOV 207′ which correlates with the camera FOV 203′ for providing indication to the user that he is within the camera FOV.

According to one embodiment the processor 202 may cause a display of control buttons or another display, to be displayed to the user, typically in response to detection of the user indicating at the camera. The control buttons may be arranged in predetermined locations in relation to the camera 203. For example, the processor 202 may cause marks 205a and 205b to be displayed on the panel 204, for example, based on detection of a user indicating at the camera 203 or based on detection of a predetermined posture or gesture of the user or based on another signal.

Thus, an image of a user indicating at a camera may be used as a reference image. The location of the user's hand (or part of the hand) in the reference image may be compared to the location of the user's indicating hand (or part of the hand) in a second image and the comparison may enable to calculate the point being indicated at in the second image. For example, when a user activates a light source by indicating at a camera (e.g., at camera view opening 206), the image of the user indicating at the camera can be used as a reference image. In a next, second, image the user may indicate at mark 205a which is, for example, located above the camera view opening 206. The location of the user's hand in the second image can be compared to the location of the user's hand in the reference image and based on this comparison it can be deduced that the user is indicating at a higher point in the second image than in the reference image. This deduction can then result, for example, in a command to brighten the light, whereas, if the user were indicating a point below the camera view opening 206 (e.g., mark 205b) then the light would be dimmed.

A method according to one embodiment, may include determining the location of a point being indicated at by a user in a first image and if the location of the point is determined to be at the location of the camera then controlling the device may include generating an ON/OFF command and/or another command, such as displaying to the user a set of control buttons or other marks arranged in predetermined locations in relation to the camera. Once it is determined that the user is indicating at the camera, the location of the hand in a second image can be determined and it may be determined if the location of the hand in the second image shows that the user is indicating at a predetermined location relative to the camera. For example, determining if the user is indicating at a predetermined location relative to the camera can be done by comparing the location of the hand in the first image to the location of the hand in the second image. If it is determined that the user is indicating at a predetermined location relative to the camera then an output of the device may be controlled, typically, based on the predetermined location

If the location of the point being indicated at in the first image is not the location of the camera it is determined if the location is a predetermined location relative to the camera. If the location is a predetermined location relative to the camera then an output of the device may be controlled.

Controlling an output of a device may include modulating the level of the output (e.g., raising or lowering volume of audio output, rewinding or running forward video or audio output, raising or lowering temperature of a heating/cooling device, etc.). Controlling the output of the device may also include controlling a direction of the output (e.g., directing air from an air-conditioner in the direction of the user, directing volume of a TV in the direction of a user, etc.). Other output parameters may be controlled.

An exemplary system, according to another embodiment of the invention, is schematically described in FIG. 2C however other systems may carry out embodiments of the present invention.

The system 2200 may include an image sensor 2203, typically associated with a processor 2202, memory 12, and a device 2201. The image sensor 2203 sends the processor 2202 image data of field of view (FOV) 2204 (the FOV including at least a user's hand or at least a user's fingers 2205) to be analyzed by processor 2202. Typically, image signal processing algorithms and/or shape detection or recognition algorithms may be run in processor 2202.

The system may also include a voice processor 22022 for running voice recognition algorithms or voice recognition software, typically to control device 2201. Voice recognition algorithms may include voice activity detection or speech detection or other known techniques used to facilitate speech and voice processing.

Processor 2202, which may be an image processor for detecting a shape (e.g., a shape of a user's hand) from an image may communicate with the voice processor 22022 to control voice control of the device 2201 based on the detected shape.

Processor 2202 and processor 22022 (which may be units of a single processor or may be separate processors) may be part of a central processing unit (CPU), a digital signal processor (DSP), a microprocessor, a controller, a chip, a microchip, an integrated circuit (IC), or any other suitable multi-purpose or specific processor or controller.

Memory unit(s) 12 may include, for example, a random access memory (RAM), a dynamic RAM (DRAM), a flash memory, a volatile memory, a non-volatile memory, a cache memory, a buffer, a short term memory unit, a long term memory unit, or other suitable memory units or storage units.

According to one embodiment a command to enable voice control of device 2201 is generated by processor 2202 or by another processor, based on the image analysis. According to some embodiments the image processing is performed by a first processor which then sends a signal to a second processor in which a command is generated based on the signal from the first processor.

Processor 2202 may run shape recognition algorithms, for example, an algorithm which calculates Haar-like features in a Viola-Jones object detection framework, to detect a hand shape which includes, for example, a V-like component (such as the “component” created by fingers 2205) or other shapes (such as the shape of the user's face and finger in a “mute” or “silence” posture 2205′) and to communicate with processor 22022 to activate, disable or otherwise control voice control of the device 2201 based on the detection of the V-like component and/or based on other shapes detected.

The system may also include an adjustable voice recognition component 2206, such as an array of microphones or a sound system. According to one embodiment the image processor (e.g., processor 2202) may generate a command to adjust the voice recognition component 2206 based on the detected shape of the user's hand or based on the detection a V-like shape. For example, a microphone may be rotated or otherwise moved to be directed at a user, once a V-like shape is detected or sound received by an array of microphones may be filtered according to the location/direction of the V-like shape with respect to the array of microphones, or the sensitivity of a sound system may be adjusted or other adjustments may be made to better enable receiving and enhancing voice signals.

In another embodiment a face recognition algorithm may be applied (e.g., in processor 2202 or another processor) to identify or classify the user according to gender/age/ethnicity, etc. and voice detection and recognition algorithms (e.g., in processor 22022 or another processor) may be more efficiently run based on the classification of the user.

In some embodiments the system includes a feedback unit 2223 which may include a light source, buzzer or sound emitting component or other component to provide an alert to the user of the detection of the user's fingers in a V-like shape (or other shapes). According to one embodiment the alert is a sound alert, which may be desired in a situation where the user cannot look at the system (e.g., while driving) to get confirmation that voice control is now enabled/disabled, etc.

The device 2201 may be any electronic device or home appliance or appliance in a vehicle that can accept user commands, e.g., TV, DVD player, PC, mobile phone, camera, set top box (STB) or streamer, etc. According to one embodiment, device 2201 is an electronic device available with an integrated 2D camera. The device 2201 may include a display 22211 or a display may be separate from but in communication with the device 2201.

The processors 2202 and 22022 may be integral to the image sensor 2203 or may be in separate units. Alternatively, the processors may be integrated within the device 2201. According to other embodiments a first processor may be integrated within the image sensor and a second processor may be integrated within the device.

The communication between the image sensor 2203 (or other sensors) and processors 2202 and 22022 (or other processors) and/or between the processors 2202 and 22022 and the device 2201 (or other devices) may be through a wired or wireless link, such as through infrared (IR) communication, radio transmission, Bluetooth technology and other suitable communication routes.

According to one embodiment the image sensor 2203 may be a 2D camera including a CCD or CMOS or other appropriate chip. A 3D camera or stereoscopic camera may also be used according to embodiments of the invention.

According to some embodiments image data may be stored in processor 2202, for example in a cache memory. Processor 2202 can apply image analysis algorithms, such as motion detection and shape recognition algorithms to identify a user's hand and/or to detect specific shapes of the user's hand and/or shapes of a hand in combination with a user's face or other shapes. Processor 2202 may perform methods according to embodiments discussed herein by for example executing software or instructions stored in memory 12.

When discussed herein, a processor such as processors 2202 and 22022 which may carry out all or part of a method as discussed herein, may be configured to carry out the method by, for example, being associated with or connected to a memory such as memory 12 storing code or software which, when executed by the processor, carry out the method.

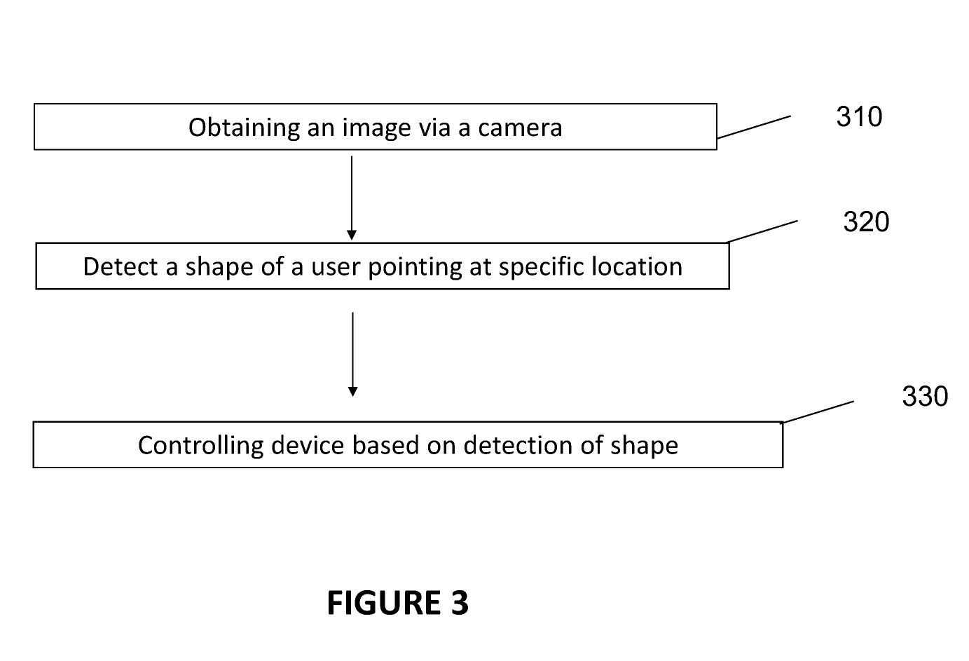

According to one embodiment which is schematically illustrated in FIG. 3, the method includes obtaining an image via a camera (310), said camera being in communication with a device. In the image a shape of a user pointing at the camera (or at a different location related to a device) is detected (320) and based on the detection of the shape of the user pointing at the camera (or other location), generating a command to control the device (330). According to one embodiment a detector trained to recognize a shape of a pointing person is used to detect the shape of the user pointing at the camera or at a different location related to a device. Shape detection algorithms, such as described above, may be used.

A shape of a user pointing at the camera can be detected in a single image, unlike detecting gestures which involve motion, which cannot be detected from a single image but requires checking at least two images.

According to one embodiment the camera is a 2D camera and the detector's training input includes 2D images.

When pointing at a camera, the user is typically looking at the camera and is holding his pointing finger in the line of sight between his eyes and the camera. Thus, a “shape of a pointing user”, according to one embodiment, will typically include at least part of the user's face. According to some embodiments a “shape of a pointing user” includes a combined shape of the user's face and the user's hand in a pointing posture (for example 21 in FIG. 2A).

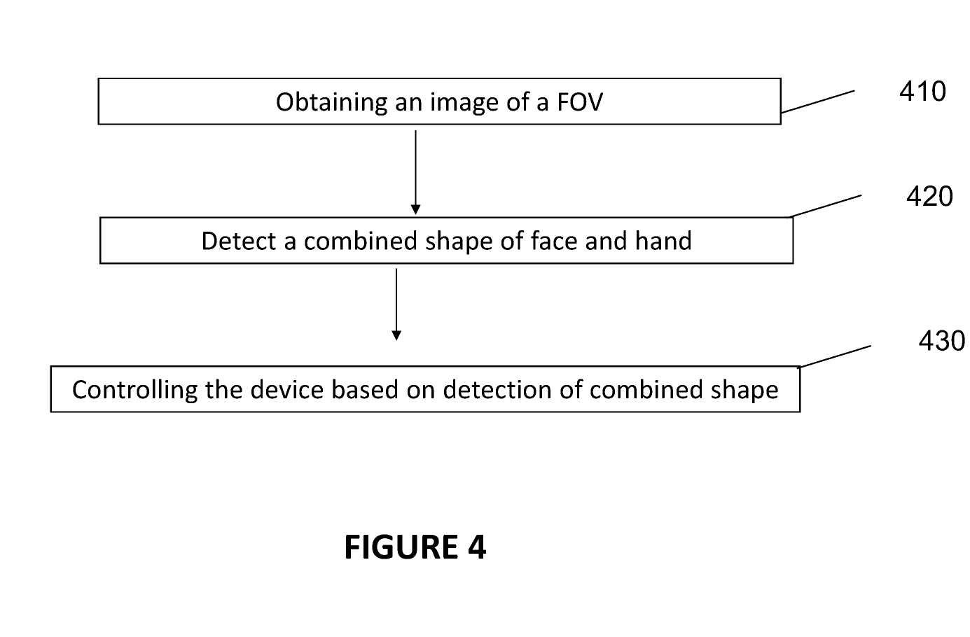

Thus, a method for computer vision based control of a device according to one embodiment, which is schematically illustrated in FIG. 4, includes the steps of obtaining an image of a field of view, the field of view including a user (410) and detecting a combined shape of the user's face (or part of the user's face) and the user's hand in a pointing posture (420). A device may then be controlled based on the detection of the combined shape (430).

According to another embodiment the device may be controlled based on detecting a combined shape of the user's face and the user's hand, the user's hand being held away from the user's face. Thus, a user does not necessarily have point in order to indicate a desired device. The user may be looking at a desired device (or at the camera attached to the device) and may raise his arm in the direction he is looking at, thus indicating that device.

For example, detection of a combined shape of the user's face (or part of the user's face) and the user's hand held at a distance from the face (but in the line of sight between his eyes and the camera), for example, in a pointing posture, may generate a command to change a first (slow) frame rate of the camera obtaining images of the user to a second (quicker) frame rate. In addition, or alternatively, the detection of the combined shape may generate a command to turn a device ON/OFF or any other command, for example as described above.

According to one embodiment one or more detectors may be used to detect a combined shape. For example, one detector may identify a partially obscured face whereas another detector may identify a hand or part of a hand on a background of a face. One or both detectors may be used in identifying a user pointing at a camera.

A face or facial landmarks may be continuously or periodically searched for in the images and may be detected, for example, using known face detection algorithms (e.g., using Intel's OpenCV). According to some embodiments a shape can be detected or identified in an image, as the combined shape, only if a face was detected in that image. In some embodiments the search for facial landmarks and/or for the combined shape may be limited to a certain area in the image (thereby reducing computing power) based for example, on size (limiting the size of the searched area based on an estimated or average face size), on location (e.g., based on the expected location of the face) and/or on other suitable parameters.

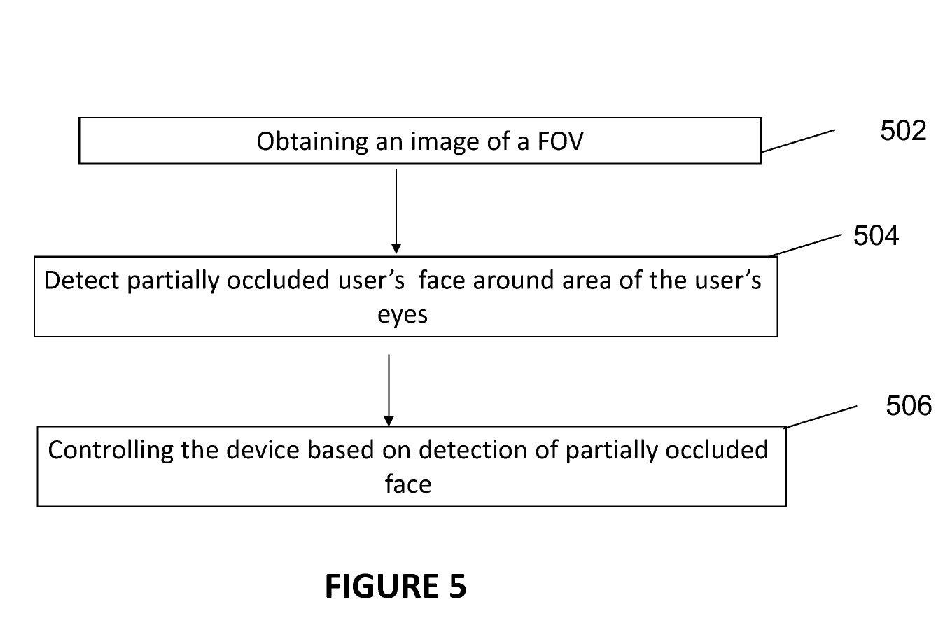

According to another embodiment detection of a user pointing at the camera or at a different location related to a device may be done by identifying a partially occluded face. For example, as schematically illustrated in FIG. 5, a method according to one embodiment of the invention may include the steps of obtaining an image via a camera (502); detecting in the image a user's face partially occluded around an area of the user's eyes (504); and controlling the device based on the detection of the partially occluded user's face (506).

The area of the eyes may be detected within a face by detecting a face (e.g., as described above) and then detecting an area of the eyes within the face. According to some embodiments an eye detector may be used to detect at least one of the user's eyes. Eye detection using OpenCV's boosted cascade of Haar-like features may be applied. Other methods may be used. The method may further include tracking at least one of the user's eyes (e.g., by using known eye trackers).

According to one embodiment the user's dominant eye is detected, or the location in the image of the dominant eye is detected, and is used to detect a pointing user. Eye dominance (also known as ocular dominance) is the tendency to prefer visual input from one eye to the other. In normal human vision there is an effect of parallax, and therefore the dominant eye is the one that is primarily relied on for precise positional information. Thus, detecting the user's dominant eye and using the dominant eye as a reference point for detecting a pointing user, may assist in more accurate control of a device.

According to one embodiment the method includes detecting a shape of a partially occluded user's face. According to one embodiment the face is partially occluded by a hand or part of a hand.

The partially occluded face may be detected in a single image by using one or more detectors, for example, as described above.

According to one embodiment, for example in a multi-device environment, the system identifies an “indication posture” and can thus determine which device (of several devices) is being indicated by the user. The “indication posture” may be a static posture (such as the user pointing at the device or at the camera associated with the device). According to one embodiment a system includes a camera operating at a low frame rate and/or having a long exposure time such that motion causes blurriness and is easily detected and discarded, facilitating detection of the static “indication posture”.

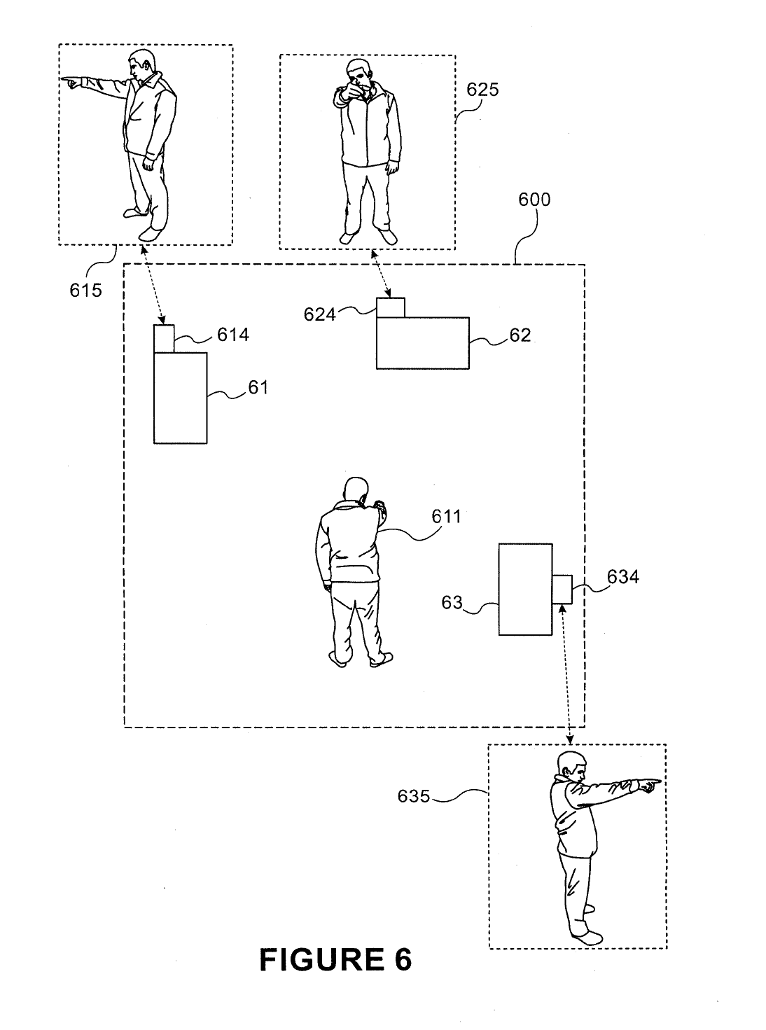

For example, as schematically illustrated in FIG. 6, a single room 600 may include several home appliances or devices that need to be turned on or off by a user, such as an audio system 61, an air conditioner 62 and a light fixture 63. Cameras 614, 624 and 634 attached at each of these devices may be operating at low energy such as at low frame rate. Each camera may be in communication with a processor (such as processor 102 in FIG. 1) to identify a user indicating at it and to turn the device on or off based on the detection of the indication posture. For example, if a user 611 is standing in the room 600 pointing at air conditioner 62, the image 625 of the user which is obtained by camera 624 which is located at or near the air conditioner will be different than the images 615 and 635 of that same user 611 obtained by the other cameras 614 and 634. Typically, the image 625 obtained by camera 624 will include a combined shape of a face and hand or a partially occluded face because the user is looking at and pointing at or near the camera 624, whereas the other images will not include a combined shape of a face and hand or a partially occluded face. Upon detection of a combined shape or partially occluded face (or other sign that the user is pointing at or near the camera), the device (e.g. air conditioner 62) may be turned on or off or may be otherwise controlled.

Some known devices can be activated based on detected motion or sound however, this type of activation is not specific and would not enable activating a specific device in a multi-device environment since movement or a sound performed by the user will be received at all the devices indiscriminately and will activate all the device instead of just one. Interacting with a display of a device may enable more specificity however typical home appliances, such as audio system 61, air conditioner 62 and light fixture 63, do not include a display. Embodiments of the current invention do not require interacting with a display and enable touchlessly activating a specific device even in a multi-device environment.

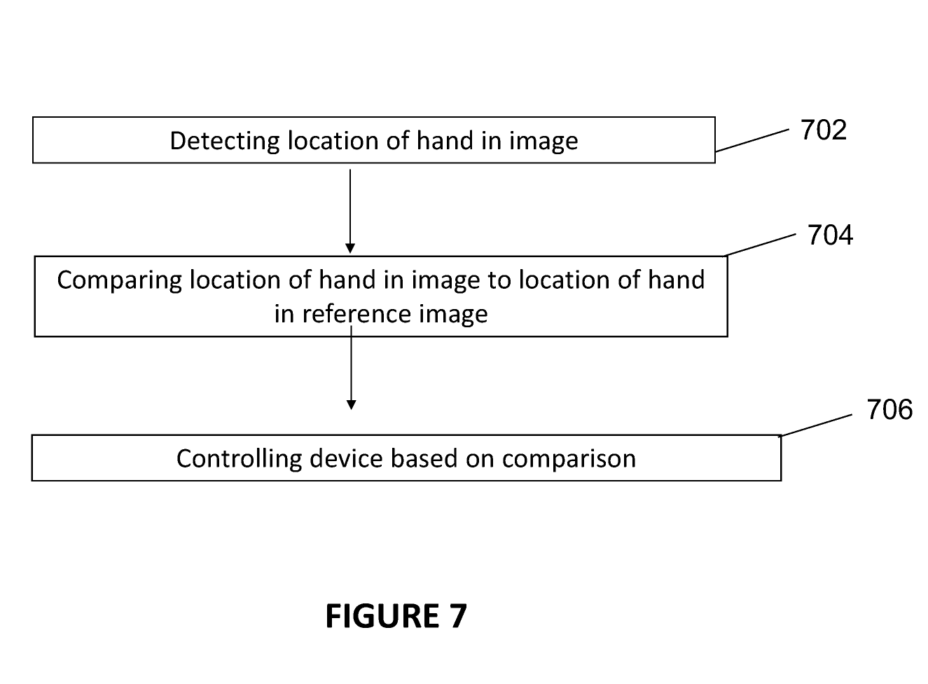

A method according to another embodiment of the invention is schematically illustrated in FIG. 7. The method includes using a processor to detect, in an image, a location of a hand (or part of a hand) of a user, the hand indicating at a point relative to the camera used to obtain the image (702), comparing the location of the hand in the image to a location of the hand in a reference image (704); and controlling the device based on the comparison (706).

According to one embodiment the reference image includes the user indicating at the camera.

Detecting the user indicating at the camera may be done, for example, by detecting the user's face partially occluded around an area of the user's eyes, as described above.

Detecting a location of a hand of a user indicating at the camera or at a point relative to the camera may include detecting the location the user's hand relative to the user's face, or part of face, for example relative to an area of the user's eyes.

According to one embodiment detecting a location of a hand of a user indicating at a camera or at a point relative to the camera involves detecting the shape of the user. The shape detected may be a combined shape of the user's face and the user's hand, the user's hand being held away from the user's face. According to one embodiment detecting the user indicating at the camera and/or at a point relative to the camera is done by detecting a combined shape of the user's face and the user's hand in a pointing posture.

According to embodiments of the invention detection of a user indicating at the camera or at a point relative to the camera may be done based on detecting a part of a hand and may include detecting specific parts of the hand. For example, detection of an indicating user may involve detection a finger or tip of a finger. A finger may be identified by identifying, for example, the longest line that can be constructed by both connecting two pixels of a contour of a detected hand and crossing a calculated center of mass of the area defined by the contour of the hand. A tip of a finger may be identified as the extreme most point in a contour of a detected hand or the point closest to the camera.

According to one embodiment a user's hand (e.g., a shape of a hand or part of hand) may be searched for in a location in an image where a face (e.g., a shape of a face) has been previously detected, thereby reducing computing power.

Detecting the user indicating at the camera may involve detecting a predetermined shape of the user's hand (e.g., the hand in a pointing posture or in another posture).

According to one embodiment, for example in a multi-device environment, the system identifies an “indication posture” and can thus determine which device (of several devices) is being indicated by the user. The “indication posture” may be a static posture (such as the user pointing at the device or at the camera associated with the device). According to one embodiment a system includes a camera operating at a low frame rate and/or having a long exposure time such that motion causes blurriness and is easily detected and discarded, facilitating detection of the static “indication posture”.

A method according to another embodiment of the invention may include using a processor to detect a reference point in an image (e.g., a first image), the reference point related to the user's face (for example, an area of the user's eyes) or the reference point being the location of a hand indicating at a camera used to obtain the image; detect in another image (e.g., a second image) a location of a hand of a user; compare the location of the hand in the second image to the location of the reference point; and control the device based on the comparison.

As described above, when a user indicates at a camera, the user is typically looking at the camera and is holding his arm/ hand in the line of sight between his eyes and the camera. Accordingly, an image of a user indicating at the camera will typically include at least part of the user's face. Thus, comparing the location of a user's hand (or part of hand) in an image to a reference point (which is related to the user's face) in that image enables to deduce the location relative to the camera at which the user is indicating and a device can be controlled based on the comparison, as described above.

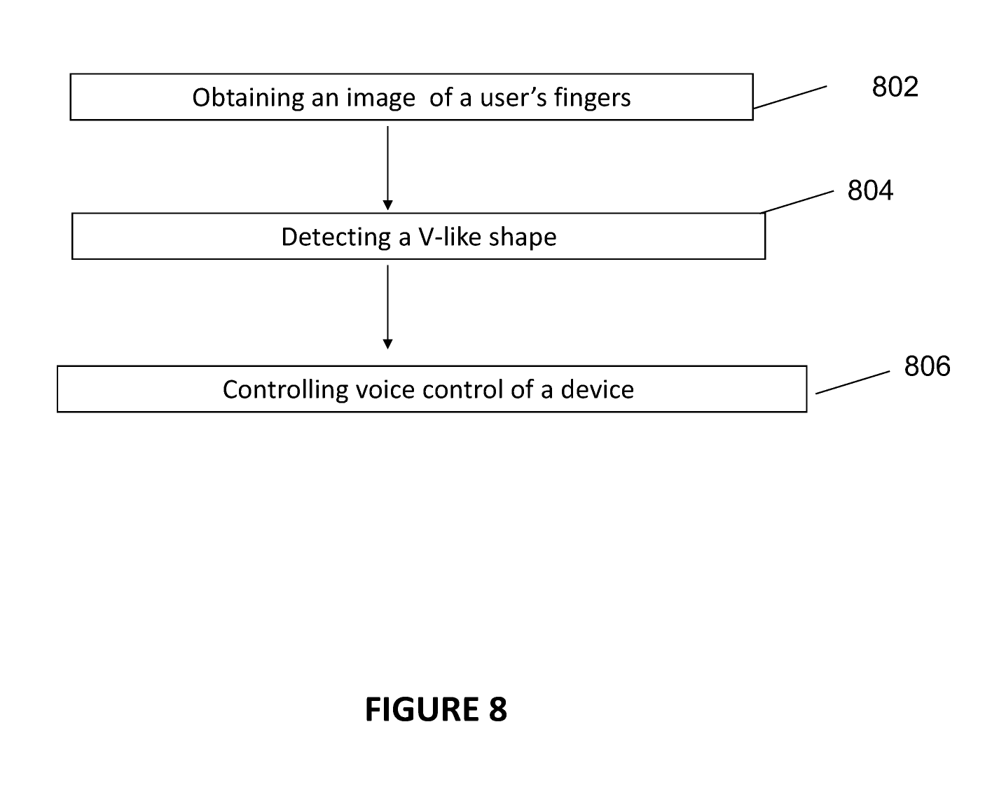

A method for computer vision based control of a device according to another embodiment of the invention is schematically illustrated in FIG. 8.

According to one embodiment the method includes obtaining an image of a field of view, which includes a user's fingers (802) and detecting in the image the user's fingers in a V-like shape (804). Based on the detection of the V-like shape voice control of a device is controlled (806).

Detecting the user's fingers in a V-like shape may be done by applying a shape detection or shape recognition algorithm to detect the user's fingers (e.g., index and middle finger) in a V-like shape. In some embodiments motion may be detected in a set of images and the shape detection algorithm can be applied based on the detection of motion. In some embodiments the shape detection algorithm may be applied only when motion is detected and/or the shape detection algorithm may be applied at a location in the images where the motion was detected.

According to one embodiment controlling voice control includes enabling or disabling voice control. Enabling voice control may include running known voice recognition algorithms or applying known voice activity detection or speech detection techniques. The step of controlling voice control may also include a step of adjusting sensitivity of voice recognition components. For example, a voice recognition component may include a microphone or array of microphones or a sound system that can be adjusted for better receiving and enhancing voice signals.

According to one embodiment the method may include generating an alert to the user based on detection of the user's fingers in a V-like shape. The alert may include a sound component, such as a buzz, click, jingle etc.

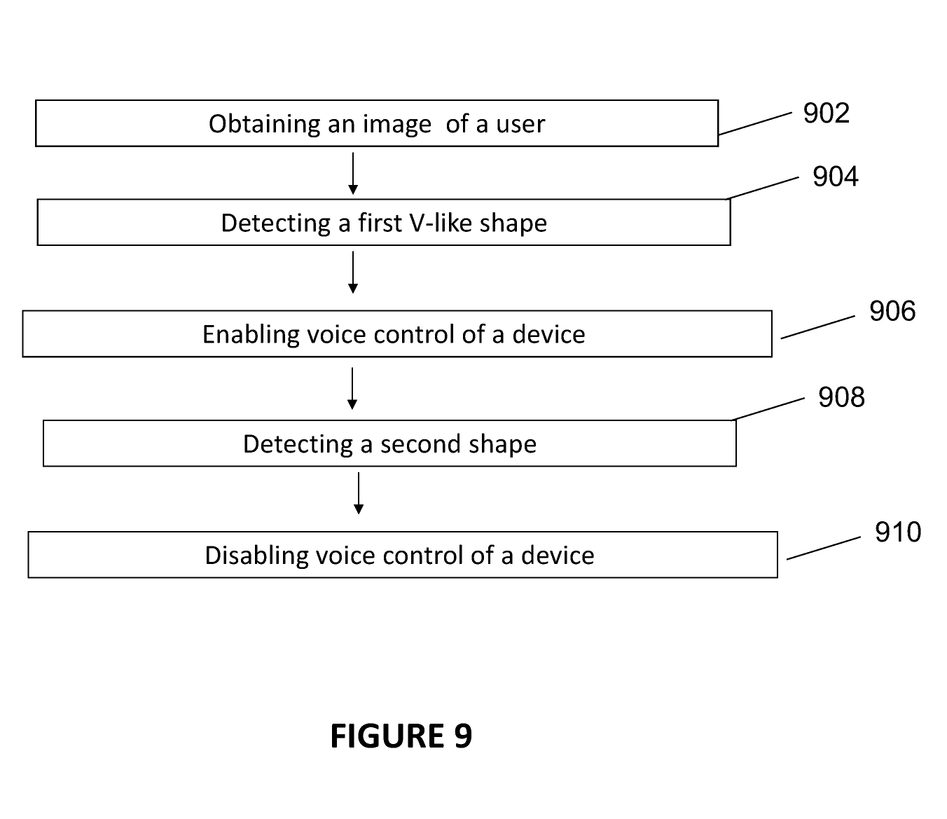

According to one embodiment, which is schematically illustrated in FIG. 9, the method includes obtaining an image of a field of view, which includes a user (902) and detecting in the image a first V-like shape (904). Based on the detection of the first V-like shape voice control of a device is enabled (906). The method further includes detecting in the image a second shape (908), which may be a second V-like shape or a different shape, typically a shape which includes the user's fingers, and disabling voice control based on the detection of the second shape (910).

In one embodiment the detection of a second V-like shape is confirmed to be the second detection (and cause a change in the status of the voice control (e.g., enabled/disabled)) only if it occurs after (e.g., within a predetermined time period) the detection of the first V-like shape.

According to one embodiment the method may include generating an alert to the user based on detection of the second shape.

According to one embodiment the second shape may be a combination of a portion of the user's face and at least a portion of the user's hand, for example, the shape of a finger positioned over or near the user's lips.

Thus, a user may toggle between voice control and other control modalities by posturing, either by using the same posture or by using different postures.

1-45. (canceled)

46. A method for computer vision based control of a device, the method comprising:
obtaining an image via a camera; and
using a processor to
detect in the image a user indicating at a location relative to the camera, and
control a device based on the detection of the user indicating at the location relative to the camera.

47. The method of claim 46 wherein controlling the device comprises generating an ON/OFF command.

48. The method of claim 46 wherein controlling the device comprises modulating a level of device output.

49. The method of claim 46 comprising using the processor to apply a shape detection algorithm to detect a shape of the user indicating at the location relative to the camera.

50. The method of claim 49 comprising changing the camera frame rate based on the detection of the shape of the user indicating at the location relative to the camera.

51. The method of claim 49 comprising using the processor to detect the shape of the user indicating at the camera based on a single frame.

52. The method of claim 46 wherein using the processor to detect a user indicating at the camera comprises detecting a user's face partially occluded around an area of the user's eyes.

53. The method of claim 46 wherein using the processor to detect a user indicating at the location relative to the camera comprises detecting a combined shape of the user's face and the user's hand, the user's hand being held away from the user's face.

54. The method of claim 46 wherein using the processor to detect a user indicating at the location relative to the camera comprises detecting a combined shape of the user's face and the user's hand in a pointing posture.

55. The method of claim 46 wherein using the processor to detect a user indicating at the location relative to the camera comprises detecting a static posture of the user.

56. The method of claim 46 wherein the location relative to the camera comprises the location of the camera.

57. The method of claim 46 comprising identifying the user and using the processor to control a device based on the detection of the user indicating at the location relative to the camera and based on the identification of the user.

58. A method for computer vision based control of a device, the method comprising:
using a processor to detect in an image a user's face partially occluded around an area of the user's eyes; and
control the device based on the detection of the partially occluded face.

59. The method of claim 58 comprising using the processor to detect a shape of the partially occluded face.

60. The method of claim 58 comprising using the processor to detect the partially occluded face in a single image.

61. A system for touchless control of a device, the system comprising:
a camera to obtain an image of at least part of a user; and
a processor to detect in the image a user indicating at the camera, and control a device based on the detection of the user indicating at the camera.

62. The system of claim 61 wherein the processor is to detect the user indicating at the camera based on detection of a shape of the user indicating at the camera.

63. The system of claim 61 comprising a mark located at predetermined location relative to the camera and wherein the processor is to detect in the image the user indicating at the mark and to control the device based on the detection of the user indicating at the camera and at the mark.

64. The system of claim 61 comprising an indicator configured to create an indicator field of view which correlates with the camera field of view for providing indication that the user is within the camera field of view.

65. The system of claim 61 wherein the device is selected from the group consisting of: a TV, DVD player, PC, mobile phone or tablet, camera, Set Top Box or streamer, smart home console or specific home appliances.
